(19) United States
(12) Patent Application Publication
(10) Pub. No.: US 2023/0005171 A1
(43) Pub. Date: Jan. 5, 2023

(54) VISUAL POSITIONING METHOD, RELATED APPARATUS AND COMPUTER PROGRAM PRODUCT

(71) Applicant: Beijing Baidu Netcom Science Technology Co., Ltd., Beijing (CN)

(72) Inventors: Wei YANG, Beijing (CN); Xiaoqing YE, Beijing (CN); Xiao TAN, Beijing (CN); Hao SUN, Beijing (CN)

(21) Appl. No.: 17/865,260

(22) Filed: Jul. 14, 2022

(30) Foreign Application Priority Data
Sep. 29, 2021 (CN) 202111147751.2

(51) Int. Cl. G06T 7/564; G06T 7/70

(52) U.S. Cl. CPC G06T 7/564; G06T 7/70; G06T 2207/20116

(57) ABSTRACT

A visual positioning method and apparatus, an electronic device, a computer readable storage medium, and a computer program product are provided. The method includes: performing contour enhancement processing on an actual building image included in a image for positioning to obtain an actual building contour, and determining location information of a target building matching the actual building contour from a preset contour map, the contour map being obtained by blurring non-building contour information in a real panoramic map, and finally generating a visual positioning result based on the location information.

The present application claims the priority of Chinese Patent Application No. 202111147751.2, titled “VISUAL POSITIONING METHOD, RELATED APPARATUS AND COMPUTER PROGRAM PRODUCT”, filed on Sep. 29, 2021, the content of which is incorporated herein by reference in its entirety.

### TECHNICAL FIELD

The present disclosure relates to the field of computer technology, in particular to the fields of artificial intelligence technologies such as computer vision and deep learning, may be applied to visual positioning and three-dimensional visual scenarios, and more particular relates to a visual positioning method and apparatus, an electronic device, a computer readable storage medium, and a computer program product.

### BACKGROUND

In order to better present scenario information to users, so that the users may acquire actual information in the scenarios and acquire navigation services based on the actual information, in existing technologies, more and more panoramic maps are used to provide related services to the users.

Panoramic map scenarios contain a large number of artificial geometric contours and textures, so they provide relatively good conditions for visual positioning tasks.

### SUMMARY

Embodiments of the present disclosure propose a visual positioning method and apparatus, an electronic device, a computer readable storage medium, and a computer program product.

Some embodiments of the present disclosure provide a visual positioning method, including: performing contour enhancement processing on an actual building image included in an image for positioning to obtain an actual building contour; determining location information of a target building matching the actual building contour from a preset contour map, the contour map being obtained by blurring non-building contour information in a real panoramic map; and generating a visual positioning result based on the location information.

Some embodiments of the present disclosure provide a visual positioning apparatus, including: an actual building contour acquiring unit, configured to perform contour enhancement processing on an actual building image included in an image for positioning to obtain an actual building contour; a location information determining unit, configured to determine location information of a target building matching the actual building contour from a preset contour map, the contour map being obtained by blurring non-building contour information in a real panoramic map; and a visual positioning result generating unit, configured to generate a visual positioning result based on the location information.

Some embodiments of the present disclosure provide a non-transitory computer readable storage medium storing computer instructions, where the computer instructions are used to cause the computer to perform the above visual positioning method.

It should be understood that the content described in this section is not intended to identify key or important features of the embodiments of the present disclosure, nor is it intended to limit the scope of the present disclosure. Other features of the present disclosure will become readily understood from the following specification.

### BRIEF DESCRIPTION OF THE DRAWINGS

Other features, objectives and advantages of the present disclosure will become more apparent upon reading the detailed description of non-limiting embodiment with reference to the following accompanying drawings.

FIG. 1 is an exemplary system architecture to which the present disclosure may be applied;

FIG. 2 is a flowchart of a visual positioning method according to an embodiment of the present disclosure;

FIG. 3 is a flowchart of another visual positioning method according to an embodiment of the present disclosure;

FIGS. 4-1, 4-2, 4-3, and 4-4 are schematic diagrams of effects of the visual positioning method in an application scenario according to an embodiment of the present disclosure;

FIG. 5 is a structural block diagram of a visual positioning apparatus according to an embodiment of the present disclosure; and

FIG. 6 is a schematic structural diagram of an electronic device suitable for performing the visual positioning method according to an embodiment of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding, and should be considered merely as examples. Therefore, those of ordinary skills in the art should realize that various changes and modifications can be made to the embodiments described herein without departing from the scope and spirit of the present disclosure. Similarly, for clearness and conciseness, descriptions of well-known functions and structures are omitted in the following description. It should be noted that the embodiments of the present disclosure and features of the embodiments may be combined with each other on a non-conflict basis.

In addition, in the technical solution of the present disclosure, the acquisition, storage, use, processing, transmission, provision and disclosure of the user personal information involved are all in compliance with the relevant laws and regulations, and do not violate public order and good customs.

FIG. 1 shows an exemplary system architecture 100 to which embodiments of a visual positioning method and apparatus, an electronic device, and a computer readable storage medium of the present disclosure may be applied.

As shown in FIG. 1, the system architecture 100 may include terminal devices 101, 102, 103, a network 104 and a server 105. The network 104 serves as a medium for providing a communication link between the terminal devices 101, 102, 103 and the server 105. The network 104 may include various types of connections, such as wired or wireless communication links, or optical fiber cables.

A user may use the terminal devices 101, 102, and 103 to interact with the server 105 through the network 104 to receive or send messages and the like. Various applications for implementing information communication between the terminal devices 101, 102, 103 and the server 105 may be installed on the terminal devices 101, 102, 103 and the server 105, such as visual positioning applications, image matching applications, or instant messaging applications.

The terminal devices 101, 102, and 103 may be hardware or software. When the terminal devices 101, 102, and 103 are hardware, they may be electronic devices having display screens, including but not limited to smart phones, tablet computers, laptop computers and desktop computers, etc.; when the terminal devices 101, 102, and 103 are software, they may be installed in the above-listed electronic devices. They may be implemented as a plurality of software or software modules, and may also be implemented as a single software or software module, which is not limited herein. When the server 105 is hardware, it may be implemented as a distributed server cluster composed of a plurality of servers, or may be implemented as a single server; when the server is software, it may be implemented as a plurality of software or software modules, or may be implemented as a single software or software module, which is not limited herein.

The server 105 may provide various services through various built-in applications. Taking a visual positioning application that can provide visual positioning services as an example, the server 105 may achieve the following effects when running the visual positioning application: first, acquiring an image for positioning from the terminal devices 101, 102, 103 through the network 104, and performing contour enhancement processing on an actual building image included in the image for positioning to obtain an actual building contour; then, the server 105 determines location information of a target building matching the actual building contour from a preset contour map, the contour map being obtained by blurring non-building contour information in a real panoramic map; and finally, the server 105 generates a visual positioning result based on the location information.

It should be noted that the image for positioning may be pre-stored locally in the server 105 in various methods in addition to being acquired from the terminal devices 101, 102 and 103 through the network 104. Therefore, when the server 105 detects that such data is already stored locally (for example, a to-be-processed visual positioning task remained before starting processing), it may choose to acquire the data directly from the local, and in this case, the exemplary system architecture 100 may also exclude the terminal devices 101, 102, 103 and the network 104.

Since storing the contour map, performing contour enhancement processing on content in the image, and matching between contours require lots of computing resources and strong computing power, the visual positioning method provided by subsequent embodiments of the present disclosure is generally executed by the server 105 with strong computing power and more computing resources, correspondingly, the visual positioning apparatus is generally also provided in the server 105. But at the same time, it should be noted that when the terminal devices 101, 102, and 103 also have computing power and computing resources that meet the requirements, the terminal devices 101, 102, and 103 may also complete the above various operations performed by the server 105 through the visual positioning applications installed thereon, and further output the same results as the server 105. Especially when there are simultaneously a plurality of terminal devices with different computing powers, and the terminal devices where the visual positioning applications are judge that they have strong computing powers and more computing resources left, the terminal devices may be allowed to perform the above operations, so as to appropriately reduce the computing pressure of the server 105, correspondingly, the visual positioning apparatus may also be provided in the terminal devices 101, 102 and 103. In this case, the exemplary system architecture 100 may also exclude the server 105 and the network 104.

It should be appreciated that the number of terminal devices, networks and servers in FIG. 1 is merely illustrative. Any number of terminal devices, networks and servers may be provided depending on the implementation needs.

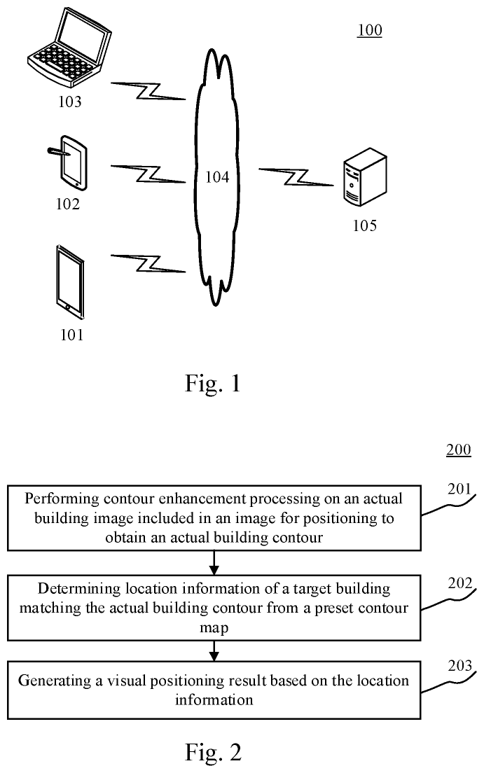

With reference to FIG. 2, FIG. 2 is a flowchart of a visual positioning method according to an embodiment of the present disclosure, where a flow 200 includes the following steps.

Step 201, performing contour enhancement processing on an actual building image included in an image for positioning to obtain an actual building contour.

In the present embodiment, after acquiring the image for positioning, an executing body of the visual positioning method (for example, the server 105 shown in FIG. 1) may perform contour enhancement processing on the actual building image included in the image for positioning to obtain the actual building contour. Generally, a contour of an actual building image in the image for positioning may be recognized by using a radial basis function (abbreviated as RBF) neural network, a back propagation (abbreviated as BP) multi-layer feedforward neural network or other neural networks, and after a recognition result is acquired, the contour enhancement processing is performed on the contour of the actual building image to obtain the actual building contour.

In practice, the contour of the actual building image included in the image for positioning may also be highlighted by sharpening content in the image for positioning or adjusting a contrast of the image for positioning, so as to achieve a purpose of enhancing and extracting the actual building contour.

It should be noted that the image for positioning may be acquired by the executing body directly from a local storage device, or may be acquired from a non-local storage device (for example, the terminal devices 101, 102, and 103 shown in FIG. 1). The local storage device may be a data storage module module in the executing body, such as a server hard disk. In this case, the image for positioning may be quickly read locally. The non-local storage device may also be any other electronic device configured to store data, such as some user terminals. In this case, the executing body may acquire the required image for positioning by sending an acquisition command to the electronic device.

Step 202, determining location information of a target building matching the actual building contour from a preset contour map.

In the present embodiment, after the actual building contour is obtained based on the above step 201, the preset contour map may be called, and the contour map is obtained by blurring non-building contour information in a real panoramic map. The real panoramic map is an image formed by de-duplicating and splicing images obtained by photographing a real scenario. The real panoramic map corresponds to the real scenario. Therefore, the real panoramic map is also called a 360-degree panoramic map, a panoramic look-around map, etc. After acquiring the contour map, the actual building contour obtained based on the above step 201 is matched with content in the contour map to determine the target building, recorded in the contour map, that matches the actual building contour, and determine the location information of the target building from the contour map.

After acquiring the content in the real panoramic map, the content (features of each content) included in the real panoramic map is identified, and then resolution-reducing, blurring and other processing are performed on the content to blur a contour of non-building content in the real panoramic map, to obtain the contour map. Preferably, the content in the real panoramic map is blurred to an extent that only contour information belonging to a building can be extracted from the obtained contour map, so as to reduce interference of content other than the building, reduce features in the contour map that are used to provide visual positioning for the image for positioning, and avoid dis-matching with the image for positioning due to too many features in the contour map.

Step 203, generating a visual positioning result based on the location information.

In the present embodiment, after the location information of the target building is determined from the contour map, a corresponding visual positioning result is generated, so as to determine a photographing location of the image for positioning based on the visual positioning result.

In the visual positioning method provided by an embodiment of the present disclosure, the contour map obtained by blurring non-building contour information in the real panoramic map may be used to provide a visual positioning service, which reduces resolution requirements for the uploaded image for positioning in the visual positioning process, so that the matching and positioning work may still be completed in the case of poor quality or few features of the image uploaded by a user.

In some optional implementations of the present embodiment, the performing contour enhancement processing on an actual building image included in an image for positioning to obtain an actual building contour, includes: extracting the actual building image included in the image for positioning; improving a contrast of an edge of an actual building in the actual building image by sharpening to obtain a sharpened image; and extracting contour information corresponding to the actual building in the sharpened image to generate the actual building contour.

In particular, after the image for positioning is acquired, the actual building image included in the image for positioning may be extracted, and the contrast of the edge of the actual building in the actual building image may be improved by sharpening. Sharpening, also known as image sharpening, is a processing method for compensating a contour of an image, enhancing an edge and grayscale transition part of an image, making the image clear. Sharpening may be divided into spatial domain processing and frequency domain processing. Image sharpening is intended to highlight the edges, contours of ground objects, or features of some linear-target features on images. This filtering method improves a contrast between a ground object edge and surrounding pixels. After improving the contrast of the edge of the actual building in the actual building image, the sharpened image may be obtained, and the actual building contour may be generated from the contour information corresponding to the actual building in the sharpened image. In this method, after the image for positioning is sharpened, the actual building contour may be acquired from the image for positioning more accurately, quickly and conveniently, thereby reducing a difficulty of acquiring the actual building contour.

In some optional implementations of the present embodiment, the visual positioning method further includes: generating photographing pose information of the image for positioning based on difference information between the actual building contour and a standard contour of the target building.

In particular, after the visual positioning result is generated based on the location information, a building corresponding to the actual building contour is determined as the target building, and the standard contour of the target building is extracted. The standard contour may be determined based on content such as the a real panoramic map photographed in advance, and the standard contour may be used to indicate a contour obtained by photographing in a standard pose.

After comparing the standard contour with the actual building contour, the difference information between the standard contour and the actual building contour is obtained. For example, the difference information may be an angle between the actual building contour and the standard contour belonging to the same spatial point, or location. After the difference information is acquired, pose information such as a photographing angle when acquiring the image for positioning may be determined based on the difference information, so as to improve the quality of visual positioning.

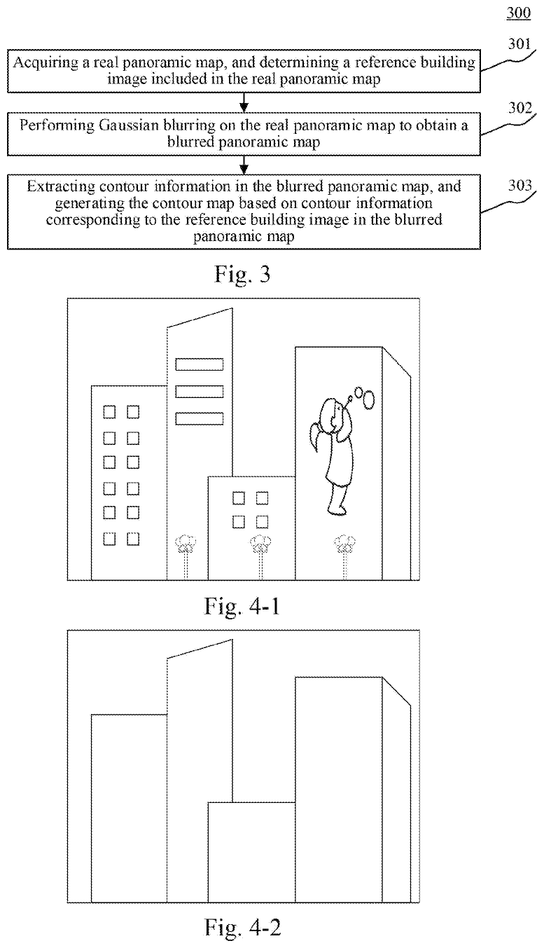

With reference to FIG. 3, FIG. 3 is a flowchart for generating a contour map, in a visual positioning method according to an embodiment of the present disclosure, where a flow 300 includes the following steps.

Step 301, acquiring a real panoramic map, and determining a reference building image included in the real panoramic map.

In the present embodiment, after the real panoramic map is acquired, content included in the real panoramic map may be identified, and the building image included in the real panoramic map may be determined.

Step 302, performing Gaussian blurring on the real panoramic map to obtain a blurred panoramic map.

In the present embodiment, a Gaussian convolution kernel may be used to perform blurring on the real panoramic map to obtain the blurred panoramic map.

In some optional implementations of the present embodiment, a size of the corresponding Gaussian convolution kernel may also be pre-determined based on resolution requirements for the blurred panoramic map obtained after blurring, and corresponding processing templates may be set corresponding to the sizes of the Gaussian convolution kernels, so as to call a corresponding configuration of the corresponding Gaussian convolution kernel by calling the processing template, and the real panoramic map is processed to obtain the blurred panoramic map of the corresponding resolution.

Further, when generating the contour map based on the blurred panoramic map subsequently, one of the blurred panoramic maps with a resolution may be selected according to an actual configuration requirement, so as to obtain the contour map corresponding to the resolution. Here, preferably, contour maps with respective clarities are generated corresponding to the blurred panoramic maps with the respective clarities. After that, based on the image for visual positioning input by the user, a contour map with the closest resolution may be selected based on the resolution of the image, so as to balance between the quality of the visual positioning service and completion of the visual positioning service.

Step 303, extracting contour information in the blurred panoramic map, and generating the contour map based on contour information corresponding to the reference building image in the blurred panoramic map.

In the present embodiment, after obtaining the blurred panoramic map based on the above step 302, a feature extractor may be used to process the blurred panoramic map to extract features included in the blurred panoramic map. After obtaining the features, contour features belonging to a reference building are kept, the contour information corresponding to the reference building image is generated, and the contour information of each reference building existing in the blurred panoramic map is summarized to form the complete contour map.

In some optional implementations of the present embodiment, the extracting contour information in the blurred panoramic map, and generating the contour map based on contour information corresponding to the reference building image in the blurred panoramic map, includes: performing edge extraction on the blurred panoramic map to obtain a binarized edge panoramic map that only includes an edge portion defined as 1 and a non-edge portion defined as 0; and generating the contour map by multiplying feature information corresponding to the reference building image in a form of a matrix and the binarized edge map.

Specifically, after extracting the features included in the blurred panoramic map, pixels corresponding to the features are marked as 1, and the rest is marked as 0, to obtain the binarized edge panoramic map, and then the feature information, corresponding to the reference building image, in the form of a matrix is used to multiply the binarized edge panoramic map, to complete the extraction of the contour information belonging to the reference building image in the binarized edge panoramic map, and finally generate the contour map. The extraction of the contour belonging to the reference building image in the binarized edge panoramic map is completed in combination with binarization, which reduces an error effect caused by the use of the blurred panoramic map for contour analysis alone, and improves the quality of the generated contour map.

In the present embodiment, the real panoramic map may be blurred based on Gaussian blurring to obtain the blurred panoramic map, and other noise contours may not be additionally generated without affecting the contour information of the original reference building image, to ensure the quality of the generated blurred panoramic map.

In order to deepen understanding, the present disclosure also provides an implementation scheme in combination with an application scenario, which is specifically described as follows.

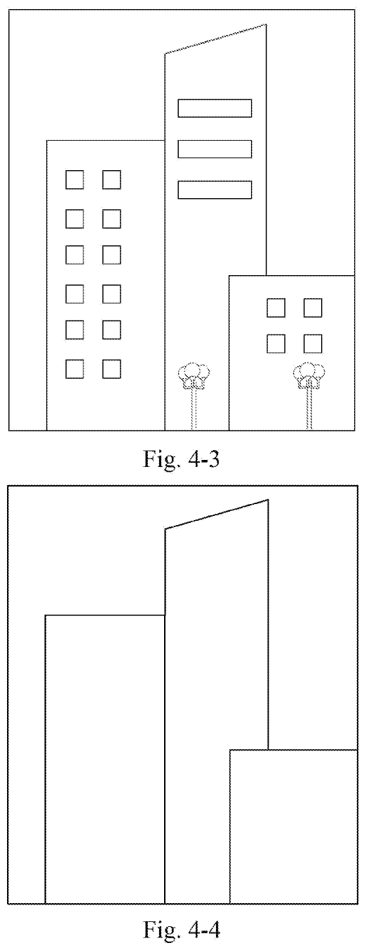

First, after acquiring a real panoramic map Iᵢ, in which some images in the real panoramic map may be as shown in FIG. 4-1, the real panoramic map Iᵢ is blurred by using a Gaussian convolution kernel with a fixed template size to obtain a blurred panoramic map Iᵢ^{blur} and a feature extractor F_{extractor} is used to perform feature extraction on the blurred panoramic map after blurring, and feature information F_{extractor}(Iᵢ^{blur}) belonging to a reference building image is determined from obtained features.

Next, edge extraction is performed on the blurred panoramic map Iᵢ^{blur}, to obtain a binarized edge panoramic map Iᵢ^{countor} that only includes an edge portion defined as 1 and a non-edge portion defined as 0, and Iᵢ^{countor} is used to multiply F_{extractor}(Iᵢ^{blur}) to obtain a contour map fᵢ^{counter} that only contains a contour corresponding to the reference building image. In the contour map, the content corresponding to the part shown in FIG. 4-1 above may be as shown in FIG. 4-2.

Further, after a image for positioning I_{query} is acquired, the image for positioning may be as shown in FIG. 4-3, contour enhancement processing is performed on an actual building image included in the image for positioning I_{query} to obtain an actual building contour I_{query}^{sharp}, and the actual building contour may be as shown in FIG. 4-4. Further, the actual building contour is input into the contour map fᵢ^{counter} for matching, to determine location information of a target building matching the actual building contour.

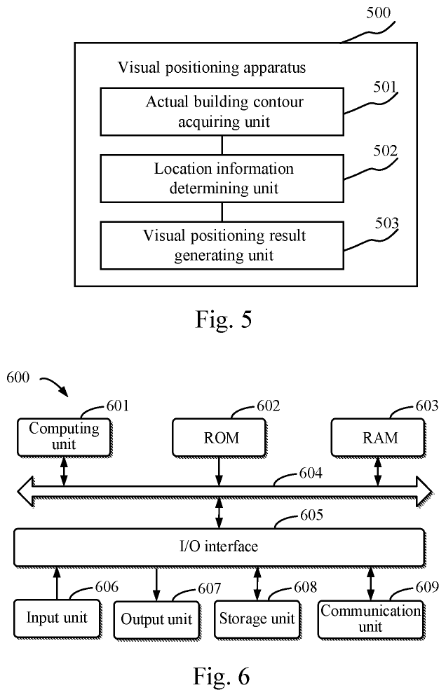

With further reference to FIG. 5, as an implementation of the method shown in the above figures, the present disclosure provides an embodiment of a visual positioning apparatus. The apparatus embodiment corresponds to the method embodiment as shown in FIG. 2. The apparatus may be applied to various electronic devices.

As shown in FIG. 5, the visual positioning apparatus 500 of the present embodiment may include: an actual building contour acquiring unit 501, a location information determining unit 502, and a visual positioning result generating unit 503. The actual building contour acquiring unit 501 is configured to perform contour enhancement processing on an actual building image included in a image for positioning to obtain an actual building contour. The location information determining unit 502 is configured to determine location information of a target building matching the actual building contour from a preset contour map, the contour map being obtained by blurring non-building contour information in a real panoramic map. The visual positioning result generating unit 503 is configured to generate a visual positioning result based on the location information.

In the present embodiment, in the visual positioning apparatus 500: for specific processing and technical effects of the actual building contour acquiring unit 501, the location information determining unit 502, and the visual positioning result generating unit 503, reference may be made to the relevant descriptions of steps 201-203 in the corresponding embodiment of FIG. 2, respectively, and detailed description thereof will be omitted.

In some alternative implementations of the present embodiment, the apparatus further includes a contour map generating unit configured to generate the contour map, and the contour map generating unit includes: a reference building image determining subunit, configured to acquire the real panoramic map, and determine a reference building image included in the real panoramic map; a blurred panoramic map generating subunit, configured to perform Gaussian blurring on the real panoramic map to obtain a blurred panoramic map; and a contour map generating subunit, configured to extract contour information in the blurred panoramic map, and generate the contour map based on contour information corresponding to the reference building image in the blurred panoramic map.

In some alternative implementations of the present embodiment, the blurred panoramic map generating subunit is further configured to: perform Gaussian blurring on the real panoramic map by using Gaussian convolution kernels of different sizes respectively, to obtain blurred panoramic maps of different blurring degrees correspondingly.

In some alternative implementations of the present embodiment, the contour map generating subunit includes: a binarization processing module, configured to perform edge extraction on the blurred panoramic map to obtain a binarized edge panoramic map that only includes an edge portion defined as 1 and a non-edge portion defined as 0; and a contour map generating module, configured to generate the contour map by multiplying feature information corresponding to the reference building image in a form of a matrix and the binarized edge map.

In some alternative implementations of the present embodiment, the actual building contour acquiring unit includes: an actual building image extracting subunit, configured to extract the actual building image included in the image for positioning; a sharpened image generating subunit, configured to improve a contrast of an edge of an actual building in the actual building image by sharpening to obtain a sharpened image; and an actual building contour generating subunit, configured to extract contour information corresponding to the actual building in the sharpened image to generate the actual building contour.

In some alternative implementations of the present embodiment, the visual positioning apparatus, further includes: a pose information generating unit, configured to generate photographing pose information of the image for positioning based on difference information between the actual building contour and a standard contour of the target building.

The present embodiment serves as the apparatus embodiment corresponding to the foregoing method embodiment, in the visual positioning apparatus provided by the present embodiment, the contour map obtained by blurring non-building contour information in the real panoramic map may be used to provide a visual positioning service, which reduces resolution requirements for the uploaded image for positioning in the visual positioning process, so that the matching and positioning work may still be completed in the case of poor image quality or few features uploaded by a user.

According to an embodiment of the present disclosure, the present disclosure also provides an electronic device, a readable storage medium, and a computer program product.

FIG. 6 shows a schematic block diagram of an example electronic device 600 that may be used to implement embodiments of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processors, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 6, the device 600 includes a computing unit 601, which may perform various appropriate actions and processing, based on a computer program stored in a read-only memory (ROM) 602 or a computer program loaded from a storage unit 608 into a random access memory (RAM) 603. In the RAM 603, various programs and data required for the operation of the device 600 may also be stored. The computing unit 601, the ROM 602, and the RAM 603 are connected to each other through a bus 604. An input/output (I/O) interface 605 is also connected to the bus 604.

A plurality of parts in the device 600 are connected to the I/O interface 605, including: an input unit 606, for example, a keyboard and a mouse; an output unit 607, for example, various types of displays and speakers; the storage unit 608, for example, a disk and an optical disk; and a communication unit 606, for example, a network card, a modem, or a wireless communication transceiver. The communication unit 606 allows the device 600 to exchange information/data with other devices over a computer network such as the Internet and/or various telecommunication networks.

The computing unit 601 may be various general-purpose and/or dedicated processing components having processing and computing capabilities. Some examples of the computing unit 601 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 601 performs the various methods and processes described above, such as the visual positioning method. For example, in some embodiments, the visual positioning method may be implemented as a computer software program, which is tangibly included in a machine readable medium, such as the storage unit 608. In some embodiments, part or all of the computer program may be loaded and/or installed on the device 600 via the ROM 602 and/or the communication unit 609. When the computer program is loaded into the RAM 603 and executed by the computing unit 601, one or more steps of the visual positioning method described above may be performed. Alternatively, in other embodiments, the computing unit 601 may be configured to perform the visual positioning method by any other appropriate means (for example, by means of firmware).

Various embodiments of the systems and technologies described in this article may be implemented in digital electronic circuit systems, integrated circuit systems, field programmable gate arrays (FPGA), application specific integrated circuits (ASIC), application-specific standard products (ASSP), system-on-chip (SOC), complex programmable logic device (CPLD), computer hardware, firmware, software, and/or their combinations. These various embodiments may include: being implemented in one or more computer programs, the one or more computer programs may be executed and/or interpreted on a programmable system including at least one programmable processor, the programmable processor may be a dedicated or general-purpose programmable processor that may receive data and instructions from a storage system, at least one input apparatus, and at least one output apparatus, and transmit the data and instructions to the storage system, the at least one input apparatus, and the at least one output apparatus.

Program codes for implementing the method of the present disclosure may be written in any combination of one or more programming languages. These program codes may be provided to a processor or controller of a general purpose computer, special purpose computer or other programmable data processing apparatus such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with a user, the systems and technologies described herein may be implemented on a computer, the computer has: a display apparatus (e.g., CRT (cathode ray tube) or LCD (liquid crystal display) monitor for displaying information to the user; and a keyboard and a pointing apparatus (for example, a mouse or trackball), the user may use the keyboard and the pointing apparatus to provide input to the computer. Other kinds of apparatuses may also be used to provide interaction with the user; for example, the feedback provided to the user may be any form of sensory feedback (for example, visual feedback, auditory feedback, or tactile feedback); and may use any form (including acoustic input, voice input, or tactile input) to receive input from the user.

The systems and technologies described herein may be implemented in a computing system (e.g., as a data server) that includes back-end components, or a computing system (e.g., an application server) that includes middleware components, or a computing system (for example, a user computer with a graphical user interface or a web browser, through which the user may interact with the embodiments of the systems and technologies described herein) that includes front-end components, or a computing system that includes any combination of such back-end components, middleware components, or front-end components. The components of the system may be interconnected by any form or medium of digital data communication (e.g., a communication network). Examples of the communication network include: local area network (LAN), wide area network (WAN), and Internet.

The computer system may include a client and a server. The client and the server are generally far from each other and usually interact through a communication network. The client and server relationship is generated by computer programs operating on the corresponding computer and having client-server relationship with each other. The server can be a cloud server, a server for a distributed system, or a server combined with blockchain.

In the technical solution according to the embodiments of the present disclosure, the contour map obtained by blurring non-building contour information in the real panoramic map may be used to provide a visual positioning service, which reduces resolution requirements for the uploaded image for positioning in the visual positioning process, so that the matching and positioning work may still be completed in the case of poor quality or few features of the image uploaded by a user.

It should be understood that various forms of processes shown above may be used to reorder, add, or delete steps. For example, the steps described in the present disclosure may be performed in parallel, sequentially, or in different orders, as long as the desired results of the technical solution disclosed in embodiments of the present disclosure can be achieved, no limitation is made herein.

The above specific embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A visual positioning method, the method comprising:
performing contour enhancement processing on an actual building image comprised in an image for positioning to obtain an actual building contour;
determining location information of a target building matching the actual building contour from a preset contour map, the contour map being obtained by blurring non-building contour information in a real panoramic map; and
generating a visual positioning result based on the location information.

2. The method according to claim 1, wherein the contour map is generated by steps comprising:
acquiring the real panoramic map, and determining a reference building image comprised in the real panoramic map;
performing Gaussian blurring on the real panoramic map to obtain a blurred panoramic map; and
extracting contour information in the blurred panoramic map, and generating the contour map based on contour information corresponding to the reference building image in the blurred panoramic map.

3. The method according to claim 2, wherein performing Gaussian blurring on the real panoramic map to obtain the blurred panoramic map, comprises:
performing Gaussian blurring on the real panoramic map by using Gaussian convolution kernels of different sizes respectively, to obtain blurred panoramic maps of different blurring degrees correspondingly.

4. The method according to claim 2, wherein extracting contour information in the blurred panoramic map, and generating the contour map based on contour information corresponding to the reference building image in the blurred panoramic map, comprises:
performing edge extraction on the blurred panoramic map to obtain a binarized edge panoramic map that only comprises an edge portion defined as 1 and a non-edge portion defined as 0; and
generating the contour map by multiplying feature information, in a form of a matrix, corresponding to the reference building image by the binarized edge map.

5. The method according to claim 1, wherein performing contour enhancement processing on an actual building image comprised in a image for positioning to obtain an actual building contour, comprises:
extracting the actual building image comprised in the image for positioning;
improving a contrast of an edge of an actual building in the actual building image by sharpening, to obtain a sharpened image; and
extracting contour information corresponding to the actual building in the sharpened image to generate the actual building contour.

6. The method according to claim 1, wherein the method further comprises:
generating photographing pose information of the image for positioning based on difference information between the actual building contour and a standard contour of the target building.

7. A visual positioning apparatus, the apparatus comprising:
at least one processor; and
a memory storing instructions, wherein the instructions when executed by the at least one processor, cause the at least one processor to perform operations, the operations comprising:
performing contour enhancement processing on an actual building image comprised in an image for positioning to obtain an actual building contour;
determining location information of a target building matching the actual building contour from a preset contour map, the contour map being obtained by blurring non-building contour information in a real panoramic map; and
generating a visual positioning result based on the location information.

8. The apparatus according to claim 7, wherein the contour map is generated by steps comprising:
acquiring the real panoramic map, and determining a reference building image comprised in the real panoramic map;
performing Gaussian blurring on the real panoramic map to obtain a blurred panoramic map; and
extracting contour information in the blurred panoramic map, and generating the contour map based on contour information corresponding to the reference building image in the blurred panoramic map.

9. The apparatus according to claim 8, wherein the steps further comprise: performing Gaussian blurring on the real panoramic map by using Gaussian convolution kernels of different sizes respectively, to obtain blurred panoramic maps of different blurring degrees correspondingly.

10. The apparatus according to claim 8, wherein the steps further comprise:
performing edge extraction on the blurred panoramic map to obtain a binarized edge panoramic map that only comprises an edge portion defined as 1 and a non-edge portion defined as 0; and
generating the contour map by multiplying feature information corresponding to the reference building image in a form of a matrix and the binarized edge map.

11. The apparatus according to claim 7, wherein the operations further comprise:
extracting the actual building image comprised in the image for positioning;
improving a contrast of an edge of an actual building in the actual building image by sharpening to obtain a sharpened image; and
extracting contour information corresponding to the actual building in the sharpened image to generate the actual building contour.

12. The apparatus according to claim 7, wherein the operations further comprise:
generating photographing pose information of the image for positioning based on difference information between the actual building contour and a standard contour of the target building.

13. A non-transitory computer readable storage medium storing computer instructions, wherein, the computer instructions are used to cause the computer to perform operations comprising:
performing contour enhancement processing on an actual building image comprised in an image for positioning to obtain an actual building contour;
determining location information of a target building matching the actual building contour from a preset contour map, the contour map being obtained by blurring non-building contour information in a real panoramic map; and
generating a visual positioning result based on the location information.

14. The non-transitory computer readable storage medium according to claim 13, wherein the contour map is generated by steps comprising:
acquiring the real panoramic map, and determining a reference building image comprised in the real panoramic map;
performing Gaussian blurring on the real panoramic map to obtain a blurred panoramic map; and
extracting contour information in the blurred panoramic map, and generating the contour map based on contour information corresponding to the reference building image in the blurred panoramic map.

15. The non-transitory computer readable storage medium according to claim 14, performing Gaussian blurring on the real panoramic map to obtain the blurred panoramic map, comprises:
performing Gaussian blurring on the real panoramic map by using Gaussian convolution kernels of different sizes respectively, to obtain blurred panoramic maps of different blurring degrees correspondingly.

16. The non-transitory computer readable storage medium according to claim 14, wherein extracting contour information in the blurred panoramic map, and generating the contour map based on contour information corresponding to the reference building image in the blurred panoramic map, comprises:
performing edge extraction on the blurred panoramic map to obtain a binarized edge panoramic map that only comprises an edge portion defined as 1 and a non-edge portion defined as 0; and
generating the contour map by multiplying feature information, in a form of a matrix, corresponding to the reference building image by the binarized edge map.

17. The non-transitory computer readable storage medium according to claim 13, wherein performing contour enhancement processing on an actual building image comprised in a image for positioning to obtain an actual building contour, comprises:
extracting the actual building image comprised in the image for positioning;
improving a contrast of an edge of an actual building in the actual building image by sharpening, to obtain a sharpened image; and
extracting contour information corresponding to the actual building in the sharpened image to generate the actual building contour.

18. The non-transitory computer readable storage medium according to claim 13, wherein the operations further comprise:
generating photographing pose information of the image for positioning based on difference information between the actual building contour and a standard contour of the target building.

19. The non-transitory computer readable storage medium according to claim 14, wherein the operations further comprise:
generating photographing pose information of the image for positioning based on difference information between the actual building contour and a standard contour of the target building.

20. The non-transitory computer readable storage medium according to claim 15, wherein the operations further comprise:
generating photographing pose information of the image for positioning based on difference information between the actual building contour and a standard contour of the target building.
